(19) United States
(12) Patent Application Publication
(10) Pub. No.: US 2015/0265488 A1
(43) Pub. Date: Sep. 24, 2015

(54) EXERCISE MACHINE

(71) Applicant: THOMAS EDWARD HAWCO, BONNYVILLE (CA)

(72) Inventor: THOMAS EDWARD HAWCO, BONNYVILLE (CA)

(21) Appl. No.: 14/218,777

(22) Filed: Mar. 18, 2014

(51) Int. Cl. A61H 1/02

(52) U.S. Cl. CPC A61H 1/0222; A61H 1/0292; A61H 2201/1642

(57) ABSTRACT

An exercise machine is disclosed herein. The exercise machine includes a first frame. The exercise machine also includes a second frame extending a length between first and second ends. The second frame is mounted to the first frame for pivoting movement about a pivot axis between a first angular position and second angular position angularly spaced from one another about the pivot axis. The pivot axis is adjacent to a first rectilinear position along the length between the first and second ends. The exercise machine also includes a foot rest mounted on the second frame at a second rectilinear position along the length. The exercise machine also includes a car for supporting a body of a user. The car is mounted on the second frame at a third rectilinear position between the first and second ends. The exercise machine also includes a moving device operably associated between the first frame and the second frame to move the second frame in the pivoting movement. The moving device including a user-engageable control positioned proximate to the second frame.

### BACKGROUND OF THE INVENTION

1. Field of the Invention

The invention relates to an exercise machine.

2. Description of Related Prior Art

U.S. Pat. No. 7,575,541 discloses a SPINE STRETCH MACHINE. The spine stretch machine comprises an inverting part and a back stretch part. The inverting part has a platform allowing a person to lie on it, an inversion motor to move the platform from horizontal to vertical, a feet anchor which is extendable driven by a leg adjustment motor, thus making the body upside down to stretch the spine. A safety release device in the inverting part can move the platform back to horizontal when the inversion motor is broken. The back stretch part has a back press unit which protrudes from the platform to press the back of the body and a second motor-driven unit which can drive the back press unit to roll back and forth alone the spine to massage the back, thus making the spine flexible.

### SUMMARY OF THE INVENTION

In summary, the invention is an exercise machine. The exercise machine includes a first frame. The exercise machine also includes a second frame extending a length between first and second ends. The second frame is mounted to the first frame for pivoting movement about a pivot axis between a first angular position and second angular position angularly spaced from one another about the pivot axis. The pivot axis is adjacent to a first rectilinear position along the length between the first and second ends. The exercise machine also includes a foot rest mounted on the second frame at a second rectilinear position along the length. The exercise machine also includes a car for supporting a body of a user. The car is mounted on the second frame at a third rectilinear position between the first and second ends. The exercise machine also includes a moving device operably associated between the first frame and the second frame to move the second frame in the pivoting movement. The moving device including a user-engageable control positioned proximate to the second frame.

### BRIEF DESCRIPTION OF THE DRAWINGS

The detailed description set forth below references the following drawings:

FIG. 1 is a first perspective view of an exemplary embodiment of the invention, wherein a second frame is in a first angular position;

FIG. 2 is a second perspective view of the exemplary embodiment of the invention, wherein a second frame is in a first angular position;

FIG. 3 is a third perspective view of a portion of the exemplary embodiment of the invention, magnified to a show a user-engageable control; and

FIG. 4 is perspective view of a moving device according to the exemplary embodiment of the invention.

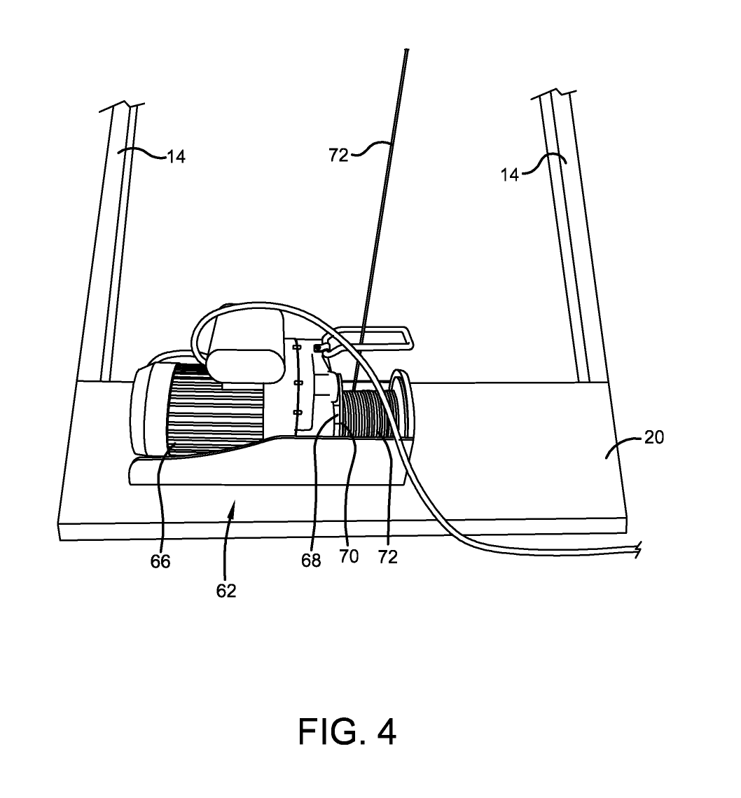

### DETAILED DESCRIPTION OF AN EXEMPLARY EMBODIMENT

The invention, as demonstrated by the exemplary embodiment described below, can provide a safe and effective exercise machine. The exemplary embodiment can allow a user to exercise the core muscles of the body, such as abdominal muscles and back muscles. The user can mount a second, pivotable frame of the exemplary embodiment when the second frame is in a first angular position. In the exemplary embodiment, the first angular position can be a substantially vertical position, making mounting easier and a more natural and thus safer motion. The user can then control a moving device with a user-engageable control to cause the second frame to pivot to a second angular position. In the second angular position, the user can be cantilevered over an open portion of the second frame. Maintaining this position for as long as possible is a form of exercise. Further, it is noted that the user can retain the user-engageable control throughout the exercise session, so that the second frame can be returned to the first angular position at any time.

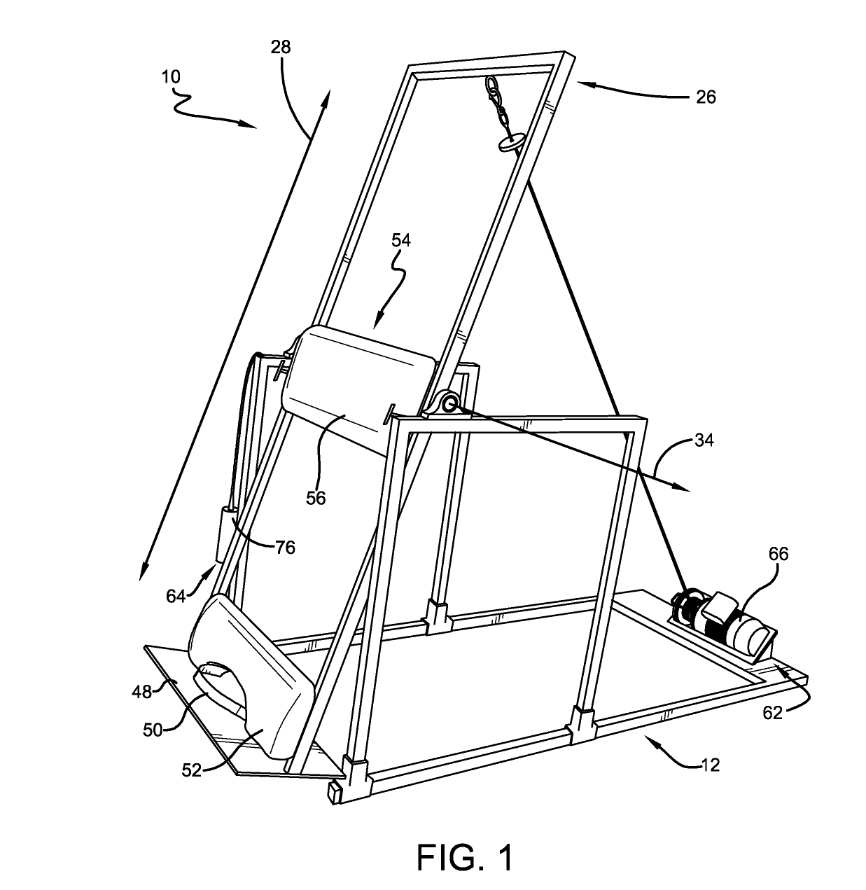

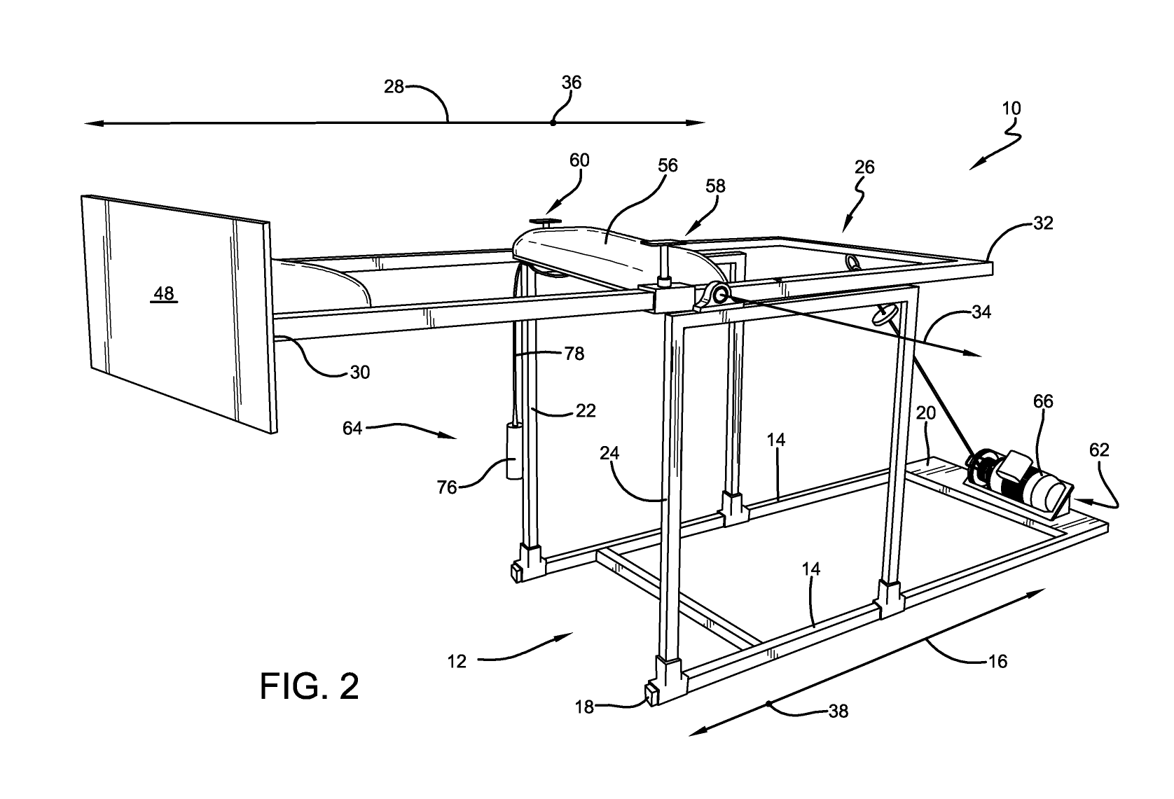

FIGS. 1-3 show an exercise machine 10 according to one embodiment of the broader invention. The exemplary exercise machine 10 includes a first frame 12. As best shown in FIG. 2, the exemplary first frame 12 includes a base portion 14 extending horizontally a length 16 between first and second ends 18, 20. The exemplary first frame 12 also includes a first support 22 extending vertically from a first side of the base portion 14. The exemplary first frame 12 also includes a second support 24 extending vertically from a second side of the base portion 14 opposite the first side. The first support 22 and the second support 24 can be positioned closer to the first end 18 than the second end 20.

The exercise machine 10 also includes a second frame 26. The exemplary second frame 26 extends a second length 28 between first and second ends 30, 32. The second frame 26 is mounted to the first support 22 and the second support 24 for pivoting movement about a pivot axis 34 between a first angular position and second angular position angularly spaced from one another about the pivot axis 34. An exemplary first angular position is shown in FIG. 1 and an exemplary second angular position is shown in FIG. 2. The pivot axis 34 is adjacent to a first rectilinear position 36 along the second length 28 between the first and second ends 30, 32. The pivot axis 34 is disposed along the first length 16 of the base portion 14 at a position 38 closer to the first end 18 of the base portion 14 than the second end 20 of the base portion 14.

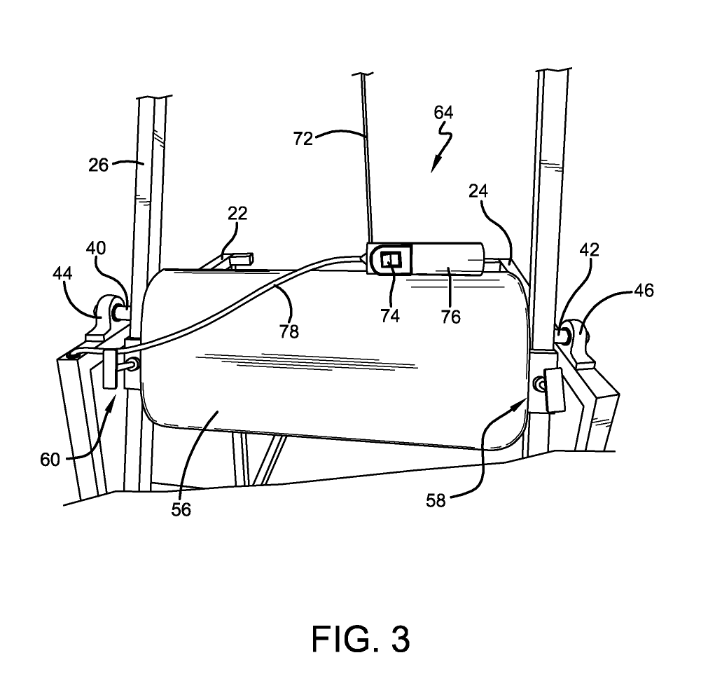

FIG. 3 shows that the exemplary second frame 26 can be supported for pivoting movement by two collinear shafts 40, 42 projecting outward. The shafts 40, 42 are centered on the pivot axis 34. The shafts 40, 42 are supported on bearings 44, 46 respectively mounted on the first and second supports 22, 24.

FIGS. 1 and 2 show that the exemplary second frame 26 is more vertically oriented in the first angular position and more horizontally oriented in the second angular position. The exemplary second frame 26 can be mounted on the first frame 12 to be passively biased to a first orientation being substantially vertical. When not subjected to moving or holding forces, the second frame 26 can settle in a substantially vertical orientation.

The exercise machine 10 also includes a foot rest 48 mounted on the second frame 26 at a second rectilinear position along the length 28. The foot rest 48 can be mounted on the second frame 26 at a second rectilinear position along the length 28, closer to the first end 30 along the second length 28 than the pivot axis 34. The user can stand on the foot rest 48 when mounting the exercise machine 10. A selectively releasable strap 50 can be positioned proximate to the foot rest 48 for securing a user's feet to the second frame 26. A pad 52 can be mounted on the frame 26 to support the user's shins

The exercise machine 10 also includes a car 54 for supporting a body of a user. The exemplary car 54 is mounted on the second frame 26 at a rectilinear position along the length 28 between the first and second ends 30, 32. The second frame 26 can be formed by steel stock of any desired cross-section. The opposite lateral sides of the second frame 26 can define rails and the car 54 can be releasably mounted on the rails. The car 54 can be selectively mountable at a plurality of different positions along the length 28 between the first and second ends 30, 32. In the exemplary embodiment, the car 54 is selectively mountable on the second frame 26 at an infinite number of different positions along the length 28 between the first and second ends 30, 32. A pad 56 can be mounted on the frame 26 to support the user's abdomen or back. Clamps 58, 60 can be engaged releasably lock the car 54 in a desired position on the frame 26.

The exercise machine 10 also includes a moving device 62 operably associated between the first frame 12 and the second frame 26 to move the second frame 26 in pivoting movement. The moving device 62 includes a user-engageable control 64 positioned proximate to the second frame 26. In the exemplary embodiment, the moving device 62 positioned at the second end 20 of the first length 16.

In the exemplary embodiment, the moving device 62 is further defined as a winch including a motor 66, a shaft 68 driven in rotation by the motor 66, and a spool 70 of cable 72 engaged for concurrent rotation with the shaft 68. The motor 66 is mounted on the first frame 12 and a first end 74 of the cable 72 is engaged with the second end 32 of the second frame 26. The motor 66 is disposed on the second end 20 of the base portion 14. The cable 72 is unwound from the spool 70 to a first exposed length when the second frame 26 is in the first angular position. The cable 72 is wound on the spool 70 to a second exposed length less than the first exposed length when the shaft 68 is rotated in a first direction, causing the second frame 26 to move to the second angular position. Rotation of the shaft 68 is a second direction opposite to the first direction results in the cable 72 being unwound back to the first exposed length. As shown by FIGS. 1 and 2, the second frame 26 is moved from a first orientation in the first angular position to a second orientation in the second angular position by the moving device 62 and the second orientation is more horizontal than the first orientation.

In other embodiments of the broader invention, the moving device could be configured differently. By way of example and not limitation, a moving device in other embodiments of the broader invention could include an hydraulic or pneumatic cylinder, a ball screw, or a worm arrangement.

In the exemplary embodiment, the foot rest 48 is disposed at the first end 28 of the second frame 26 and the moving device 62 engages the second frame 26 at the second end 32. The foot rest 48 and the car 54 are both positioned on a first side of the first rectilinear position 36 along the length 28. The foot rest 48 is positioned on a first side of the first rectilinear position 36 along the length 28 and the second frame 26 is open on a second side of the first rectilinear position 36 along the length 28 opposite the first side. As a result, the user is operable to pass through the second frame 26 on the second side while supported by the car 54 and the foot rest 48. This allows for other forms of exercise.

The exemplary user-engageable control 64 includes a switch 74. The motor 66 is activated by manipulation of the switch 74 of the user-engageable control 64. The switch 74 can be mounted in a graspable handle 76 supported by the first frame 12 through the flexible cord 78. The flexible cord 78 allows the user to grasp and retain the user-engageable control 64 through a full range of the pivoting movement. The switch 74 can also be used to disengage the motor 66. Disengagement of the motor 66 means the motor 66 is not imposing a force on the second frame 26, a moving force or a holding force. When the motor 66 is disengaged, the second frame 26 is gravity-biased and moves to a more vertical orientation.

In operation, the user can mount the second frame 26 when the second frame 26 is in the first angular position. The user can step on the foot rest 48 and affix the strap 50 around her or his ankles or shins In the exemplary embodiment, the first angular position can be a substantially vertical position, making mounting easier and therefore safer. The user can then rest her or his core (front/abdomen or rear/back) against the car 54 and grasp the handle 76. The user can press the switch 74 and the motor 66 will rotate the shaft 68 and spool 70. The cable 72 wound around the spool 70 will retract, causing the second frame 26 to pivot to the second angular position. In the second angular position, the user can be cantilevered over an open portion of the second frame 26. Maintaining this position for as long as possible will allow the user to strengthen her or his core. The user can retain the user-engageable control 64 throughout the exercise session, so that the second frame 26 can be returned to the first angular position when the user has become fatigued.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. An exercise machine comprising:
a first frame;
a second frame extending a length between first and second ends and mounted to said first frame for pivoting movement about a pivot axis between a first angular position and second angular position angularly spaced from one another about said pivot axis, wherein said pivot axis is adjacent to a first rectilinear position along said length between said first and second ends;
a foot rest mounted on said second frame at a second rectilinear position along said length;
a car for supporting a body of a user and mounted on said second frame at a third rectilinear position between said first and second ends; and
a moving device operably associated between said first frame and said second frame to move said second frame in said pivoting movement, said moving device including a user-engageable control positioned proximate to said second frame.

2. The exercise machine of claim 1 wherein said foot rest is disposed at said first end of said second frame and said moving device engages said second frame at said second end.

3. The exercise machine of claim 1 wherein said foot rest and said car are both positioned on a first side of said first rectilinear position along said length.

4. The exercise machine of claim 3 said moving device engages said second frame at said second end.

5. The exercise machine of claim 1 wherein said foot rest is positioned on a first side of said first rectilinear position along said length and said second frame is open on a second side of said first rectilinear position along said length opposite said first side, such that a user is operable to pass through said second frame on said second side while supported by said car and said foot rest.

6. The exercise machine of claim 1 wherein said car is further definable as selectively mountable at a plurality of different positions along said length between said first and second ends.

7. The exercise machine of claim 6 wherein said car is further definable as selectively mountable at an infinite number of different positions along said length between said first and second ends.

8. The exercise machine of claim 1 wherein said car is further definable as releasably mounted on said second frame.

9. The exercise machine of claim 1 wherein said moving device is further defined as:
a winch including a motor, a shaft driven in rotation by said motor, and a spool of cable engaged for concurrent rotation with said shaft, wherein said motor is mounted on said first frame and a first end of said cable is engaged with said second end of said second frame.

10. The exercise machine of claim 9 wherein said user-engageable control is further defined as one of a button and a switch, wherein said motor is activated by manipulation of said user-engageable control.

11. The exercise machine of claim 9 wherein said cable is unwound from said spool a first exposed length when said second frame is in said first angular position and wound on said spool to a second exposed length less than said first exposed length when said second frame is in said second angular position.

12. The exercise machine of claim 11 wherein said second frame is more vertically oriented in said first angular position and more horizontally oriented in said second angular position.

13. The exercise machine of claim 1 wherein said second frame is moved from a first orientation to a second orientation by said moving device and wherein said second orientation is more horizontal than said first orientation.

14. The exercise machine of claim 13 wherein said second frame is gravity-biased and moves to a more vertical orientation when said moving device is disengaged.

15. The exercise machine of claim 1 wherein said user-engageable control is further defined as one of a button and a switch, wherein said motor is activated by manipulation of said user-engageable control, and wherein said user-engageable control is supported by the first frame through a flexible cord such that a user can grasp and retain said user-engageable control through a full range of said pivoting movement.

16. An exercise machine comprising:
a first frame having a base portion extending horizontally a first length between first and second ends, a first support extending vertically from a first side of said base portion, and a second support extending vertically from a second side of said base portion opposite said first side, wherein said first support and said second support are positioned closer to said first end than said second end;
a second frame extending a second length between first and second ends and mounted to said first support and said second support for pivoting movement about a pivot axis between a first angular position and second angular position angularly spaced from one another about said pivot axis, wherein said pivot axis is adjacent to a first rectilinear position along said second length between said first and second ends, wherein said pivot axis is disposed along said first length of said base portion closer to said first end of said base portion than said second end of said base portion;
a foot rest mounted on said second frame at a second rectilinear position closer to said first end along said second length than said pivot axis;
a car for supporting a body of a user mounted on said second frame at a third rectilinear position between said first and second ends;
a moving device operably associated between said first frame and said second frame to move said second frame in said pivoting movement, said moving device including a user-engageable control positioned proximate to said second frame, and said moving device positioned at said second end of said first length.

17. The exercise machine of claim 16 wherein said moving device includes a motor disposed on said second end of said base portion.

18. The exercise machine of claim 16 further comprising:
a selectively releasable strap positioned proximate to said foot rest for securing a user's feet to said second frame.

19. The exercise machine of claim 16 wherein said second frame is mounted on said first frame to be passively biased to a first orientation being substantially vertical.

20. The exercise machine of claim 19 wherein said user-engageable control is further defined as including a switch mounted in a graspable handle and a flexible cord extending from said handle.
